(19) United States
(12) Patent Application Publication
(10) Pub. No.: US 2025/0314811 A1
(43) Pub. Date: Oct. 9, 2025

(54) FILTER

(71) Applicant: FUJIFILM Corporation, Tokyo (JP)

(72) Inventors: Yukito SAITOH, Kanagawa (JP); Yujiro YANAI, Kanagawa (JP); Kazuya HISANAGA, Kanagawa (JP)

(73) Assignee: FUJIFILM Corporation, Tokyo (JP)

(21) Appl. No.: 19/245,441

(22) Filed: Jun. 23, 2025

Related U.S. Application Data
(63) Continuation of application No. PCT/JP2023/046188, filed on Dec. 22, 2023.

(30) Foreign Application Priority Data
Dec. 27, 2022 (JP) 2022-209699

(51) Int. Cl. G02B 5/20; G02B 5/30

(52) U.S. Cl. CPC G02B 5/20; G02B 5/3016

(57) ABSTRACT

An object of the present invention is to provide a novel filter that is used as a band-pass filter or the like. To achieve the object, three or more liquid crystal layer sets, each consisting of a first liquid crystal layer formed by twisting, aligning, and fixing a liquid crystal compound and a second liquid crystal layer in which a twisted direction of a liquid crystal compound is opposite to that in the first liquid crystal layer, are provided, alignment directions of the liquid crystal compound are parallel to each other at an interface between the first liquid crystal layer and the second liquid crystal layer, and a twisted angle of the liquid crystal compound in the first liquid crystal layer and a twisted angle of the liquid crystal compound in the second liquid crystal layer are equal.

### CROSS-REFERENCE TO RELATED APPLICATIONS

This application is a Continuation of PCT International Application No. PCT/JP2023/046188 filed on Dec. 22, 2023, which claims priority under 35 U.S.C. § 119(a) to Japanese Patent Application No. 2022-209699 filed on Dec. 27, 2022. The above applications are hereby expressly incorporated by reference, in their entirety, into the present application.

### BACKGROUND OF THE INVENTION

### 1. Field of the Invention

The present invention relates to an optical filter.

### 2. Description of the Related Art

A band-pass filter that transmits light in a specific wavelength range and blocks light in other wavelength ranges is used in various optical devices.

As the band-pass filter, a polarization interference filter formed of a dielectric multi-layer film, a filter in which a polarizer and a birefringent crystal are combined, or the like is known.

In addition, a band-pass filter is also known, which is formed by alternately stacking a birefringent plate (λ/2 plate) in which an angle formed between a direction of a transmission axis of a polarizer and a slow axis is +ρ, and a birefringent plate in which the angle is −ρ, both of which have the same thickness, between polarizers disposed in crossed nicols, as described in JP2004-101577A.

Furthermore, JP2004-101577A proposes an optical filter (band-pass filter) with a small number of components, which is an optical filter consisting of crystals and having a structure in which two types of polarization regions having different crystals are periodically arranged, and in which the principal axis of an index ellipsoid cut parallel to an interface between the two different types of polarization regions is different in the two different types of polarization regions.

### SUMMARY OF THE INVENTION

As described above, band-pass filters having various configurations are known.

An object of the present invention is to provide a novel filter that is different from any of the filters and can be used as a band-pass filter or the like.

In order to achieve the object, the present invention has the following configurations.
[1] A filter comprising: three or more liquid crystal layer sets in a thickness direction, each consisting of
   a first liquid crystal layer formed by fixing a liquid crystal compound twisted and aligned in the thickness direction, and
   a second liquid crystal layer formed by fixing the liquid crystal compound twisted and aligned in the thickness direction, in which a twisted direction of the liquid crystal compound is opposite to a twisted direction of the liquid crystal compound in the first liquid crystal layer,
in which, in the liquid crystal layer set, an alignment direction of the liquid crystal compound on a surface of the first liquid crystal layer on a second liquid crystal layer side is parallel to an alignment direction of the liquid crystal compound on a surface of the second liquid crystal layer on a first liquid crystal layer side, and
a twisted angle of the liquid crystal compound in the first liquid crystal layer and a twisted angle of the liquid crystal compound in the second liquid crystal layer are equal.
[2] The filter according to [1], further comprising: polarizers between which the three or more liquid crystal layer sets are interposed in the thickness direction,
in which the polarizers between which the three or more liquid crystal layer sets are interposed in the thickness direction are disposed so that transmission axes of the polarizers are orthogonal to each other.
[3] The filter according to [1] or [2], in which the twisted angle of the liquid crystal compound in the first liquid crystal layer and the second liquid crystal layer and Δnd in the first liquid crystal layer and the second liquid crystal layer are different between the liquid crystal layer sets disposed on both sides in the thickness direction and the liquid crystal layer sets disposed in a center portion in the thickness direction.
[4] The filter according to any one of [1] to [3], in which the liquid crystal compound in the first liquid crystal layer includes a rod-like liquid crystal compound and a disk-like liquid crystal compound, and the liquid crystal compound in the second liquid crystal layer includes a rod-like liquid crystal compound and a disk-like liquid crystal compound.
[5] The filter according to any one of [1] to [4], in which the first liquid crystal layer and the second liquid crystal layer include an infrared absorbing colorant.
[6] The filter according to any one of [1] to [5], in which the first liquid crystal layer and the second liquid crystal layer include a liquid crystal elastomer.
[7] The filter according to any one of [1] to [6], in which, in a case where a total number of the first liquid crystal layers and the second liquid crystal layers stacked is denoted by N and the twisted angle of the liquid crystal compound in the first liquid crystal layer and the second liquid crystal layer is denoted by ±φ [°], the following expression is satisfied,

$$0.9 \times ( 129.05 \times {N}^{- 0.961} ) \leq \vert φ \vert \leq 1.1 \times ( 129.05 \times {N}^{- 0.961} ) .$$

[8] The filter according to any one of [2] to [7], further comprising: a retardation layer provided between one or both of the polarizers and the three or more liquid crystal layer sets,
in which an in-plane slow axis of the retardation layer is parallel to an absorption axis of any of the polarizers.

According to the present invention, a novel filter that can be used as a band-pass filter or the like is provided.

### BRIEF DESCRIPTION OF THE DRAWINGS

FIG. 1 is a view conceptually showing an example of a filter according to an embodiment of the present invention.

FIG. 2 is a graph for describing the filter according to the embodiment of the present invention.

FIG. 3 is a graph for describing the filter according to the embodiment of the present invention.

FIG. 4 is a view conceptually showing another example of the filter according to the embodiment of the present invention.

FIG. 5 is a graph for describing the filter shown in FIG. 4.

### DESCRIPTION OF THE PREFERRED EMBODIMENTS

Hereinafter, a filter according to an embodiment of the present invention will be described in detail based on suitable embodiments shown in the accompanying drawings.

In the present specification, a numerical range represented by “to” means a range including numerical values before and after “to” as a lower limit value and an upper limit value.

In addition, all of the drawings shown below are conceptual views for describing the present invention, and the positional relationship, size, thickness, shape, and the like of each constituent element are different from the actual ones.

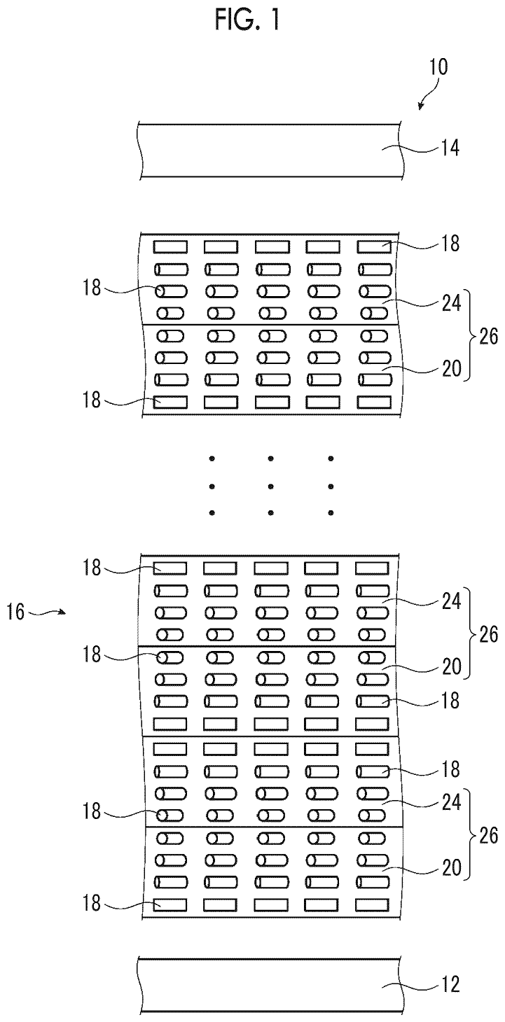

FIG. 1 conceptually shows an example of a filter according to the embodiment of the present invention.

A filter 10 shown in FIG. 1 is a band-pass filter (narrow-band filter) that transmits light in a specific wavelength range and blocks light in other wavelength ranges, and has a first polarizer 12, a second polarizer 14, and a liquid crystal polarization interference element 16. The liquid crystal polarization interference element 16 is disposed between the first polarizer 12 and the second polarizer 14.

In the filter 10 in the example shown in the drawing, the first polarizer 12 and the second polarizer 14 are provided as a preferable aspect.

That is, the filter according to the embodiment of the present invention may consist of only the liquid crystal polarization interference element 16 in the filter 10 in the example shown in the drawing.

The first polarizer 12 and the second polarizer 14 are polarizers (polarizing plates) that transmit linearly polarized light in a predetermined direction, and are disposed in crossed nicols with their transmission axes orthogonal to each other.

The first polarizer 12 and the second polarizer 14 are not limited, and various known linear polarizers such as an iodine-based polarizer, a dye-based polarizer using a dichroic dye, a polyene-based polarizer, and a wire grid polarizer can be used.

In the filter 10 in the example shown in the drawing, the liquid crystal polarization interference element 16 is disposed between the first polarizer 12 and the second polarizer 14.

The first polarizer 12 and the second polarizer 14 are spaced from the liquid crystal polarization interference element 16 in FIG. 1.

However, the present invention is not limited thereto, and the first polarizer 12, the second polarizer 14, and the liquid crystal polarization interference element 16 may be stacked in contact with each other. In addition, in a case where the first polarizer 12 and the second polarizer 14 are in contact with the liquid crystal polarization interference element 16, they may be adhered to each other with an adhesive transparent to transmitted light, such as an optical clear adhesive (OCA) or an acrylic pressure sensitive adhesive, as necessary.

The liquid crystal polarization interference element 16 is an optical element that acts as a λ/2 retardation plate for light in a specific wavelength range (specific wavelength) and does not act as a retardation layer for light in other wavelength ranges.

As described above, the first polarizer 12 and the second polarizer 14 are polarizers that are disposed in crossed nicols with their transmission axes orthogonal to each other.

Accordingly, of the light entering the filter 10, only linearly polarized light in a predetermined direction transmits through the first polarizer 12. In the linearly polarized light, the polarization direction of light having a specific wavelength is rotated by 90° by the liquid crystal polarization interference element 16, and the light having a specific wavelength enters and transmits through the second polarizer 14 disposed in crossed nicols with respect to the first polarizer 12. Meanwhile, the liquid crystal polarization interference element 16 does not act as a retardation layer for light in a wavelength range other than the specific wavelength range. Accordingly, the light enters the second polarizer 14 disposed in crossed nicols with respect to the first polarizer 12 and is blocked.

With such an optical action, the filter 10 functions as a band-pass filter that transmits only light in a specific wavelength range and blocks other light.

The liquid crystal polarization interference element 16 is formed by stacking an even number of liquid crystal layers each formed by fixing a liquid crystal compound 18 twisted and aligned in a thickness direction. The liquid crystal compound 18 is a rod-like liquid crystal compound.

Specifically, the liquid crystal polarization interference element 16, that is, the filter according to the embodiment of the present invention is formed by alternately stacking a first liquid crystal layer 20 formed by fixing the liquid crystal compound 18 twisted and aligned in the thickness direction and a second liquid crystal layer 24 formed by fixing the liquid crystal compound 18 twisted and aligned in the thickness direction, in which the twisted direction of the liquid crystal compound 18 is opposite to that in the first liquid crystal layer 20.

The liquid crystal polarization interference element 16 has a configuration in which one combination of the first liquid crystal layer 20 and the second liquid crystal layer 24 constitutes one liquid crystal layer set 26 and three or more liquid crystal layer sets 26 are stacked in the thickness direction.

Accordingly, the total number of the first liquid crystal layers 20 and the second liquid crystal layers 24 stacked is an even number.

In one liquid crystal layer set 26, the alignment direction of the liquid crystal compound 18 on a surface of the first liquid crystal layer 20 on the second liquid crystal layer 24 side is parallel to the alignment direction of the liquid crystal compound on a surface of the second liquid crystal layer 24 on the first liquid crystal layer 20 side.

That is, in one liquid crystal layer set 26, the alignment directions of the liquid crystal compound 18 are parallel to each other at an interface between the first liquid crystal layer 20 and the second liquid crystal layer 24.

In one liquid crystal layer set 26, the alignment direction of the liquid crystal compound 18 on the surface of the first liquid crystal layer 20 on the second liquid crystal layer 24 side and the alignment direction of the liquid crystal compound 18 on the surface of the second liquid crystal layer 24 on the first liquid crystal layer 20 side can be detected by obliquely cutting the liquid crystal polarization interference element 16 and analyzing the alignment direction of the liquid crystals on the surface of a cross section.

This method is described in detail in “Depth-Dependent Determination of Molecular Orientation for WV-Film” (FMC8-3, IDW'04, 651 to 654) written by Yohei Takahashi et al.

Furthermore, in one liquid crystal layer set 26, a twisted angle of the liquid crystal compound 18 in the thickness direction in the first liquid crystal layer 20 is the same as a twisted angle of the liquid crystal compound 18 in the thickness direction in the second liquid crystal layer 24.

As described above, the twisted direction of the liquid crystal compound 18 in the thickness direction in the first liquid crystal layer 20 is opposite to that in the second liquid crystal layer 24. That is, for example, in a case where the twisted angle of the liquid crystal compound 18 in the first liquid crystal layer 20 is “φ [°]”, the twisted angle of the liquid crystal compound 18 in the second liquid crystal layer 24 is “−φ [°]”.

Accordingly, in one liquid crystal layer set 26, the liquid crystal compound 18 is twisted up to a certain angle in the first liquid crystal layer 20 in the thickness direction, and is twisted to return to the original state in the second liquid crystal layer 24. For example, in a case where the twisted angle of the liquid crystal compound 18 in the thickness direction is 30°, the liquid crystal compound 18 is twisted from 0° to 30° in the first liquid crystal layer 20, and then twisted from 30° to 0° in the second liquid crystal layer 24.

In the present example, for example, the twisted angle of the liquid crystal compound is defined as 0° in the direction of the transmission axis of the first polarizer 12, and is positive (+) in the clockwise direction and negative (−) in the counterclockwise direction.

That is, absolute values of the twisted angles in the first liquid crystal layer 20 and the second liquid crystal layer 24 are the same.

As described above, in the liquid crystal polarization interference element 16, the first liquid crystal layer 20 and the second liquid crystal layer 24 are alternately stacked in the thickness direction, in which the liquid crystal compound 18 (rod-like liquid crystal compound) is twisted and aligned in the thickness direction, the liquid crystal compound 18 has a parallel alignment at an interface, the twisted directions of the liquid crystal compound 18 are opposite to each other, and the absolute values of the twisted angles are the same.

That is, the light passing through the liquid crystal polarization interference element 16 alternately and repeatedly receives influences of the slow axis that rotates by a predetermined angle in one direction and the slow axis that rotates by a predetermined angle in the opposite direction. For example, in a case where the absolute value of the twisted angle of the liquid crystal compound 18 is 30°, the light passing through the liquid crystal polarization interference element 16 alternately and repeatedly receives the influence of the slow axis that rotates from 0° to 30° and the influence of the slow axis that rotates from 30° to 0°.

Therefore, in the liquid crystal polarization interference element 16, by setting Δnd's of the first liquid crystal layer 20 and the second liquid crystal layer 24 according to the wavelength range transmitted through the filter 10, and adjusting the twisted angle of the liquid crystal compound in the first liquid crystal layer 20 and the second liquid crystal layer 24 according to the total number of the first liquid crystal layers 20 and the second liquid crystal layers 24 stacked, it is possible to form a liquid crystal polarization interference element 16 that acts as a λ/2 retardation plate for light in a specific wavelength range and does not act as a retardation plate for light in other wavelength ranges, that is, in which no retardation is felt.

The number of liquid crystal layer sets 26 in the liquid crystal polarization interference element 16 can be detected by obliquely cutting the liquid crystal polarization interference element 16 and analyzing the alignment direction of the liquid crystals on the surface of a cross section. This method is described in detail in the above-described document written by Yohei Takahashi et al.

In addition, a change in the twisted direction of the liquid crystals can be known based on the difference in components in a depth direction of the element by using a time-of-flight secondary ion mass spectrometry (TOF-SIMS) device or the like, with the difference in chiral agent as a background. Examples of the TOF-SIMS device include TOF.SIMS 5 manufactured by ION-TOF GmbH.

In the Δnd's of the first liquid crystal layer 20 and the second liquid crystal layer 24 constituting the liquid crystal polarization interference element 16, Δn is birefringence of the liquid crystal compound 18 constituting the first liquid crystal layer 20 and the second liquid crystal layer 24. In addition, d represents the thickness of the first liquid crystal layer 20 and the second liquid crystal layer 24. Δn can be measured by using AxoScan manufactured by Axometrics, Inc.

In the present invention, the Δnd's of the first liquid crystal layer 20 and the second liquid crystal layer 24 are equal.

As described above, the liquid crystal polarization interference element 16 acts as a λ/2 retardation plate only for light in a specific wavelength range. Accordingly, the Δnd's of the first liquid crystal layer 20 and the second liquid crystal layer 24 are wavelength at which the liquid crystal polarization interference element 16 is assumed to act as a λ/2 retardation plate, that is, half (half wavelength) a central wavelength of a wavelength range assumed to be transmitted through the filter 10.

For example, in a case where the wavelength at which the liquid crystal polarization interference element 16 acts as a λ/2 retardation plate, that is, the central wavelength of a wavelength range transmitted through the filter 10 is assumed to be 550 nm, the Δnd's of the first liquid crystal layer 20 and the second liquid crystal layer 24 are set to 275 nm.

The Δnd's of the first liquid crystal layer 20 and the second liquid crystal layer 24 may have an error of about ±10% with respect to half the central wavelength of the wavelength range transmitted through the filter 10.

For the twisted angle of the liquid crystal compound 18 in the first liquid crystal layer 20 and the second liquid crystal layer 24 constituting the liquid crystal polarization interference element 16, an optimum twisted angle at which the liquid crystal polarization interference element 16 acts as a λ/2 retardation plate is set by simulation according to the central wavelength of the wavelength range assumed to be transmitted through the filter 10 and a total number N of the first liquid crystal layers 20 and the second liquid crystal layers 24 stacked.

A general optical simulation unit can be used for the simulation. Otherwise, calculation can be performed using LCD Master 1D (manufactured by SHINTECH Co., Ltd., Ver 9.8.0.0).

Here, according to the simulation by the inventors of the present invention, a twisted angle φ of the liquid crystal compound 18 in the first liquid crystal layer 20 and the second liquid crystal layer 24 with respect to the total number N of the first liquid crystal layers 20 and the second liquid crystal layers 24 is as follows:
the twisted angle φ is 63.6° in a case where the number N of the stacked layers is 2 (one liquid crystal layer set);
the twisted angle φ is 35.5° in a case where the number N of the stacked layers is 4 (two liquid crystal layer sets);
the twisted angle φ is 23.6° in a case where the number N of the stacked layers is 6 (three liquid crystal layer sets);
the twisted angle φ is 17.7° in a case where the number N of the stacked layers is 8 (four liquid crystal layer sets);
the twisted angle φ is 14.1° in a case where the number N of the stacked layers is 10 (five liquid crystal layer sets);
the twisted angle φ is 11.8° in a case where the number N of the stacked layers is 12 (six liquid crystal layer sets);
the twisted angle φ is 10.1° in a case where the number N of the stacked layers is 14 (seven liquid crystal layer sets); and
the twisted angle φ is 8.8° in a case where the number N of the stacked layers is 16 (eight liquid crystal layer sets).

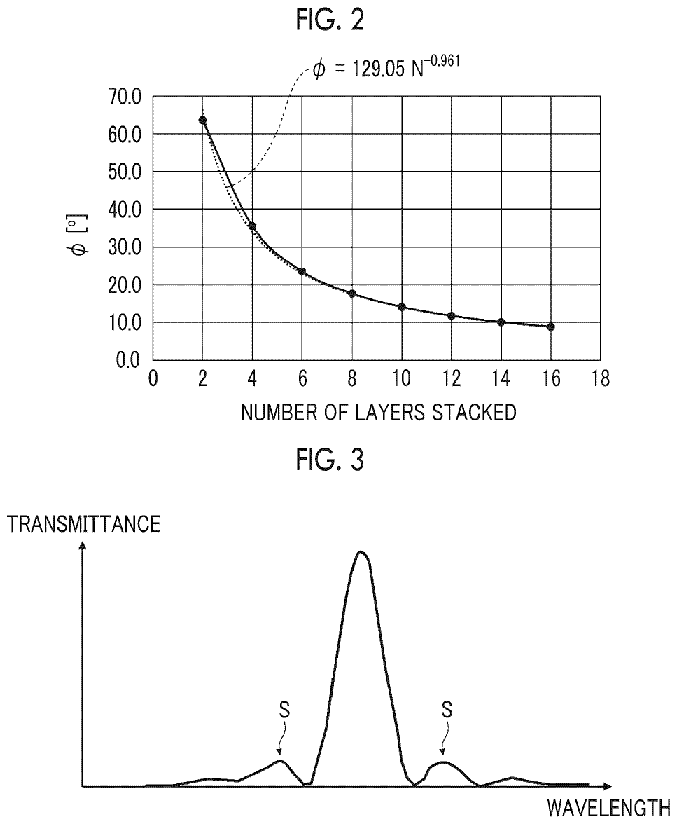

As conceptually shown in FIG. 2, in a case where the results (solid line) are fitted to an approximate curve (broken line), it suitably matches the following expression:

$$φ = 12 \; 9.05 \times {N}^{- 0.961}$$

Accordingly, in the present invention, the twisted angle ±φ [°] of the liquid crystal compound 18 in the first liquid crystal layer 20 and the second liquid crystal layer 24, corresponding to the total number N of the first liquid crystal layers 20 and the second liquid crystal layers 24 stacked preferably satisfy:

$$0.9 \times ( 129.05 \times {N}^{- 0.961} ) \leq \vert φ \vert \leq 1.1 \times ( 129.05 \times {N}^{- 0.961} ) ,$$

and more preferably satisfy:

$$\vert φ \vert = 129.05 \times {N}^{- 0.961} .$$

The absolute values of the twisted angles of the liquid crystal compound 18 in the first liquid crystal layer 20 and the second liquid crystal layer 24 are not limited to being identical to each other, and may have an error of ±10% or less of the absolute value of the twisted angle.

It is preferable that the error be small, and it is most preferable that the absolute values of the twisted angles of the liquid crystal compound 18 in the first liquid crystal layer 20 and the second liquid crystal layer 24 be identical to each other.

The twisted angle of the liquid crystal compound 18 in the first liquid crystal layer 20 and the second liquid crystal layer 24 constituting the liquid crystal polarization interference element 16 can be detected by obliquely cutting the liquid crystal polarization interference element 16 and analyzing the alignment direction of the liquid crystals on the surface of a cross section. This method is described in detail in the above-described document written by Yohei Takahashi et al.

In addition, the twisted angle of the liquid crystal compound 18 can also be measured by using AxoScan (manufactured by Axometrics, Inc.) with a separate measurement unit in which a model with parameters input thereto is assumed.

The thickness d of the first liquid crystal layer 20 and the second liquid crystal layer 24 is not limited, and a thickness may be appropriately set so that the Δnd is half the central wavelength of the wavelength range transmitted through the filter 10 according to the liquid crystal compound 18 used.

The thickness d of the first liquid crystal layer 20 and the second liquid crystal layer 24 is preferably 1 to 5 μm, and more preferably 1 to 3 μm.

The first liquid crystal layer 20 and the second liquid crystal layer 24 are usually formed by using the same liquid crystal compound 18. In addition, the Δnd's of the first liquid crystal layer 20 and the second liquid crystal layer 24 are equal. Accordingly, the thicknesses of the first liquid crystal layer 20 and the second liquid crystal layer 24 are equal.

The total number N of the first liquid crystal layers 20 and the second liquid crystal layers 24 stacked is not limited as long as the number of the liquid crystal layer sets 26 is three or more, that is, six or more layers are stacked, and the number of layers stacked is an even number.

The total number N of the first liquid crystal layers 20 and the second liquid crystal layers 24 stacked is preferably 6 to 30, more preferably 6 to 20, and still more preferably 6 to 10.

In the filter 10 according to the embodiment of the present invention, the larger the total number N of the first liquid crystal layers 20 and the second liquid crystal layers 24 stacked, that is, the larger the number of the liquid crystal layer sets 26, the narrower the wavelength range in which the liquid crystal polarization interference element 16 acts as the λ/2 retardation layer.

Accordingly, in the filter 10 according to the embodiment of the present invention, the larger the total number N of the first liquid crystal layers 20 and the second liquid crystal layers 24 stacked, the narrower the half-width of the wavelength range of the transmitted light. In other words, the filter 10 can be made as a band-pass filter having a narrower transmission wavelength range as the total number N of the first liquid crystal layers 20 and the second liquid crystal layers 24 stacked is increased.

Accordingly, as the total number N of the first liquid crystal layers 20 and the second liquid crystal layers 24 stacked, that is, the number of the liquid crystal layer sets 26, a smaller number of layers may be selected for a case where a broad bandwidth is required, and a larger number of layers may be selected for a case where a narrow bandwidth is required, depending on a required width of the transmission wavelength range of the filter 10.

The liquid crystal polarization interference element 16 may be produced by a known method.

For example, it is produced by a coating method using a liquid crystal composition for forming the first liquid crystal layer 20 and the second liquid crystal layer 24.

First, an alignment film aligned in one direction is formed on an appropriately selected support.

As the alignment film, known alignment films can be used, such as a rubbed film consisting of an organic compound such as a polymer, an obliquely vapor-deposited film of an inorganic compound, a film having microgrooves, a film obtained by accumulating a Langmuir-Blodgett (LB) film of an organic compound such as ω-tricosanoic acid, dioctadecylmethylammonium chloride, and methyl stearate by a Langmuir-Blodgett method, and a film obtained by applying a coating liquid for forming an alignment film containing a photo-alignment material to a surface of a support, drying the coating liquid, and exposing the coating film using a polarizer such as a wire grid polarizer.

A composition (liquid crystal composition) for forming the first liquid crystal layer 20 and a composition for forming the second liquid crystal layer 24, which contain a liquid crystal compound and a chiral agent functioning to induce the twisted alignment of the liquid crystal compound in the thickness direction, are prepared.

The twisted direction of the liquid crystal compound 18 in the thickness direction in the first liquid crystal layer 20 is opposite to that in the second liquid crystal layer 24, but by selecting the chiral agent, the twisted direction of the liquid crystal compound in the thickness direction can be selected. In addition, by adjusting the amount of the chiral agent to be added, the twisted angle of the liquid crystal compound 18 in the thickness direction can be adjusted.

A solvent for preparing the composition is not limited and can be appropriately selected depending on the purpose, and an organic solvent is preferable. The organic solvent is not particularly limited, and can be appropriately selected depending on the purpose. Examples of the organic solvent include ketones, alkyl halides, amides sulfoxides, a heterocyclic compound, hydrocarbons, esters, and ethers. These may be used alone or in combination of two or more kinds. Among these, ketones are preferable in consideration of an environmental burden.

The composition for forming the first liquid crystal layer 20 is applied to a surface of the formed alignment film to align the liquid crystal compound 18, and is dried. The composition is cured by ultraviolet irradiation or the like as necessary to form the first liquid crystal layer 20.

Next, the composition for forming the second liquid crystal layer 24 is applied to a surface of the formed first liquid crystal layer 20, and is dried. The composition is cured by ultraviolet irradiation or the like as necessary to form the second liquid crystal layer 24, and one liquid crystal layer set is formed.

Here, in a case where the liquid crystal layer is formed on the liquid crystal layer using the coating method, the alignment of the upper liquid crystal layer follows the alignment of the liquid crystal compound on the surface of the lower liquid crystal layer.

Accordingly, the alignment direction of the liquid crystal compound 18 in the first liquid crystal layer 20 is parallel to (matches) the alignment direction of the liquid crystal compound 18 in the second liquid crystal layer 24 at the interface between the first liquid crystal layer 20 and the second liquid crystal layer 24.

Next, the composition for forming the first liquid crystal layer 20 is applied to a surface of the formed second liquid crystal layer 24, and is dried. The composition is cured by ultraviolet irradiation or the like as necessary to form the first liquid crystal layer 20.

In the liquid crystal polarization interference element 16 constituting the filter 10 according to the embodiment of the present invention, the twist of the liquid crystal compound 18 in the thickness direction in the first liquid crystal layer 20 and the twist of the liquid crystal compound 18 in the thickness direction in the second liquid crystal layer have the same twisted angle, and twists are in opposite directions. Accordingly, in a case where the angle of the alignment of the liquid crystal compound 18 at the interface between the first liquid crystal layer 20 formed on the surface of the alignment film and the alignment film is defined as 0°, the angle of the alignment of the liquid crystal compound 18 on the upper surface of the second liquid crystal layer 24 also returns to 0°.

In addition, as described above, in a case where the liquid crystal layer is formed on the liquid crystal layer using the coating method, the alignment of the upper liquid crystal layer follows the alignment of the liquid crystal compound on the surface of the lower liquid crystal layer.

Accordingly, at the interface between the second liquid crystal layer 24 and the first liquid crystal layer 20, the alignment direction of the liquid crystal compound 18 in the second liquid crystal layer 24 and the alignment direction of the liquid crystal compound 18 in the first liquid crystal layer 20 are parallel to each other at 0°.

Next, the formation of the second liquid crystal layer 24 on the surface of the formed first liquid crystal layer 20, the formation of the first liquid crystal layer 20 on the surface of the formed second liquid crystal layer 24, and the formation of the second liquid crystal layer 24 on the surface of the formed first liquid crystal layer 20 are repeated as many times as the number of liquid crystal layers to be formed, that is, the number of liquid crystal layer sets to be formed, to produce the liquid crystal polarization interference element 16.

Furthermore, for example, the alignment direction of the liquid crystal compound 18 in the first liquid crystal layer 20 formed first is aligned with the transmission axis of the first polarizer 12 (angle 0°), the second polarizer 14 is disposed in crossed nicols with respect to the first polarizer 12 to interpose the liquid crystal polarization interference element 16 therebetween in the thickness direction (stacking direction), and thus the filter 10 is obtained as shown in FIG. 1.

A liquid crystal layer consisting of a rod-like liquid crystal compound (rod-like liquid crystal layer) and a liquid crystal layer consisting of a disk-like liquid crystal compound (disk-like liquid crystal layer) each have higher and lower refractive indices (birefringence indices).

Here, in a case where a larger refractive index and a smaller refractive index of the rod-like liquid crystal layer are denoted by nc1 and nc2, respectively, and a larger refractive index and a smaller refractive index of the disk-like liquid crystal layer are denoted by nd1 and nd2, respectively, it is preferable that the values of nc1 and nd2 be close to each other and the values of nc2 and nd2 be close to each other from the viewpoint of suppressing unnecessary reflected light. Specifically, the difference between these values is preferably 0.05 or less. For example, values such as nc1=1.71, nc2=1.55, nd1=1.67, and nd2=1.51 are preferable.

In addition, these refractive indices can be optically measured by peeling off the liquid crystal layer. For example, the refractive index can be obtained as follows: after a treatment is performed so that the specular reflectance from the rear surface of the liquid crystal layer is 0, the incidence direction of linearly polarized light during the measurement of a reflection spectrum using a spectrophotometer (manufactured by JASCO Corporation, ultraviolet-visible-near infrared spectrophotometer V-750) is adjusted parallel to the axis of each refractive index to be measured, and the angle dependence of the reflectance obtained from the measurement is fitted to a calculation formula.

In the liquid crystal polarization interference element 16 of the filter 10 according to the embodiment of the present invention, the first liquid crystal layer 20 and the second liquid crystal layer 24 are not limited to those directly stacked using the coating method as described above. That is, the liquid crystal polarization interference element 16 may be provided by producing a sheet-like first liquid crystal layer 20 and a sheet-like second liquid crystal layer 24, and alternately stacking and bonding them to each other with an optical bonding layer transparent to transmitted light, such as an OCA, an acrylic pressure sensitive adhesive, an adhesive, and a polymer layer. In this case, the refractive index of the optical bonding layer is preferably close to the refractive index of the liquid crystals from the viewpoint of improving a transmittance. Specifically, the difference in refractive index is preferably 0.3 or less. In addition, the refractive index of the optical bonding layer is preferably a value between two birefringence indices of the liquid crystals since the difference in refractive index is small from either of the two birefringence indices.

However, in consideration of the transmittance of transmitted light, the first liquid crystal layer 20 and the second liquid crystal layer 24 directly stacked without an adhesive layer or the like using the coating method are preferable.

In the filter 10 (liquid crystal polarization interference element 16) according to the embodiment of the present invention, the liquid crystal compound 18 (rod-like liquid crystal compound) is not limited, and various known liquid crystal compounds can be used.

As the rod-like liquid crystal compound, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolanes, and alkenylcyclohexylbenzonitriles are preferably used. In the present invention, not only the above-described low-molecular-weight liquid crystalline molecules but also polymer liquid crystalline molecules can be used.

It is more preferable that the alignment of the rod-like liquid crystal compound be fixed by polymerization.

As a polymerizable rod-like liquid crystal compound, compounds described in Makromol. Chem., vol. 190, p. 2255 (1989), Advanced Materials, vol. 5, p. 107 (1993), U.S. Pat. Nos. 4,683,327A, 5,622,648A, 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), JP2001-64627, and the like can be used. Furthermore, as the rod-like liquid crystal compound, for example, compounds described in JP1999-513019A (JP-H11-513019A) and JP2007-279688A can also be preferably used.

As described above, the chiral agent functions to induce the twisted alignment of the liquid crystal compound in the thickness direction. The chiral agent may be selected according to the purpose since the induced helical twisted direction or helical pitch varies depending on the compound.

The chiral agent is not particularly limited. For example, a known compound, an isosorbide, or an isomannide derivative can be used. Examples of the known compound include compounds described in “Liquid Crystal Device Handbook (No. 142 Committee of Japan Society for the Promotion of Science, 1989), Chapter 3, Article 4-3, chiral agent for twisted nematic (TN) or super twisted nematic (STN), p. 199”. The isosorbide is specifically a chiral agent having an isosorbide structure.

In addition, as the chiral agent, a chiral agent in which back isomerization, dimerization, isomerization, or the like occurs due to light irradiation so that helical twisting power (HTP) decreases can also be suitably used.

The chiral agent generally includes an asymmetric carbon atom, but an axially asymmetric compound or a planar asymmetric compound, including no asymmetric carbon atom, can also be used as the chiral agent. Examples of the axially chiral compound or the planar chiral compound include binaphthyl, helicene, paracyclophane, and derivatives thereof. The chiral agent may have a polymerizable group. In a case where both the chiral agent and the liquid crystal compound have a polymerizable group, a polymer having a repeating unit derived from the polymerizable liquid crystal compound and a repeating unit derived from the chiral agent can be formed by a polymerization reaction of the polymerizable chiral agent and the polymerizable liquid crystal compound. In this aspect, the polymerizable group of the polymerizable chiral agent is preferably the same as the polymerizable group of the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent has a photoisomerization group, a pattern having a desired reflection wavelength corresponding to a luminescence wavelength can be formed by irradiation of actinic rays or the like through a photo mask after coating and alignment, which is preferable. As the photoisomerization group, an isomerization portion of a photochromic compound, an azo group, an azoxy group, or a cinnamoyl group is preferable. Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, and JP2003-313292A.

The twisted angle of the liquid crystal compound 18 in the thickness direction changes depending on the amount of the chiral agent to be added.

Accordingly, by selecting the chiral agent and appropriately setting the amount thereof to be added, the twisted direction and the twisted angle of the liquid crystal compound 18 in the first liquid crystal layer 20 and the second liquid crystal layer 24 can be optionally set.

In addition to the liquid crystal compound and the chiral agent, a polymerization initiator, a leveling agent, a crosslinking agent, a surfactant, or the like may be added to the composition for forming the first liquid crystal layer 20 and the second liquid crystal layer 24, as necessary.

In the filter 10 shown in FIG. 1, all the first liquid crystal layers 20 are the same, and all the second liquid crystal layers 24 are also the same. That is, in the filter 10 shown in FIG. 1, all the first liquid crystal layers 20 have the same Δnd and the same twisted angle of the liquid crystal compound 18, and all the second liquid crystal layers 24 have the same Δnd and the same twisted angle of the liquid crystal compound 18.

However, the present invention is not limited thereto, and the liquid crystal layers may have a distribution of Δnd and a distribution of the twisted angle of the liquid crystal compound 18 in the thickness direction. That is, in the filter according to the embodiment of the present invention, in a case where, in the first liquid crystal layer and the second liquid crystal layer, the Δnd's are equal, the twisted directions of the liquid crystal compound 18 are opposite to each other, and the twisted angles (absolute values of the twisted angles) are equal, the Δnd and the twisted angle of the liquid crystal compound 18 may be different between the liquid crystal layer sets.

For example, a configuration in which the And of the liquid crystal layer and the twisted angle of the liquid crystal compound 18 are different between the liquid crystal layer sets in the center in the thickness direction (stacking direction) and the liquid crystal layer sets on both sides in the thickness direction is exemplified.

Specifically, compared to the liquid crystal layer of the liquid crystal layer sets in the center in the thickness direction, the Δnd of the liquid crystal layer of the liquid crystal layer sets on both sides in the thickness direction may be increased and the twisted angle of the liquid crystal compound 18 may be reduced.

As will be shown later in examples, for example, in a case where a filter (liquid crystal polarization interference element) has eight liquid crystal layers, that is, four liquid crystal layer sets,
a configuration is exemplified in which, in the first liquid crystal layer set, Δnd of the first liquid crystal layer (first layer) is denoted by Δnd1, a twisted angle of the liquid crystal compound is denoted by φ1, Δnd of the second liquid crystal layer (second layer) is denoted by Δnd1, and a twisted angle of the liquid crystal compound is denoted by −φ1,
in the second liquid crystal layer set, And of the first liquid crystal layer (third layer) is denoted by Δnd2 that is smaller than Δnd1, a twisted angle of the liquid crystal compound is denoted by φ2 that is larger than φ1, And of the second liquid crystal layer (fourth layer) is denoted by Δnd2, and a twisted angle of the liquid crystal compound is denoted by −φ2,
in the third liquid crystal layer set, Δnd of the first liquid crystal layer (fifth layer) is denoted by Δnd2, a twisted angle of the liquid crystal compound is denoted by φ2, Δnd of the second liquid crystal layer (sixth layer) is denoted by Δnd2, and a twisted angle of the liquid crystal compound is denoted by −φ2, and
in the fourth liquid crystal layer set, Δnd of the first liquid crystal layer (seventh layer) is denoted by Δnd1, a twisted angle of the liquid crystal compound is denoted by φ1, Δnd of the second liquid crystal layer (eighth layer) is denoted by Δnd1, and a twisted angle of the liquid crystal compound is denoted by −φ1.

In the band-pass filter, as conceptually shown in FIG. 3, a transmission wavelength region, which is called a side lobe, is generated as shown by the arrow S in the drawing at a position of a shorter wavelength and a position of a longer wavelength than a target transmission wavelength range, with the target transmission wavelength range interposed therebetween.

Regarding this, as described above, in a case where, compared to the liquid crystal layer of the liquid crystal layer sets in the center in the thickness direction, the Δnd of the liquid crystal layer of the liquid crystal layer sets on both sides in the thickness direction is increased and the twisted angle of the liquid crystal compound 18 is reduced, the side lobe can be reduced.

The Δnd of the liquid crystal layer may be adjusted by changing the thickness of the liquid crystal layer, for example. However, the Δnd of the liquid crystal layer may be adjusted by changing the liquid crystal compound to be used.

In addition, the twisted angle of the liquid crystal compound may be adjusted by changing the kind and/or amount of the chiral agent to be added.

In such a configuration in which, compared to the liquid crystal layer of the liquid crystal layer sets in the center in the thickness direction, the Δnd of the liquid crystal layer of the liquid crystal layer sets on both sides in the thickness direction is increased and the twisted angle of the liquid crystal compound 18 is reduced, the number of the liquid crystal layers in the center, in which the Δnd of the liquid crystal layer is increased and the twisted angle of the liquid crystal compound 18 is reduced compared to those on both sides, that is, the method of dividing the liquid crystal layer sets on both sides and in the center is not limited, and may be appropriately set according to the number of the liquid crystal layers (liquid crystal layer sets) of the filter.

In addition, regarding the Δnd and the twisted angle of the liquid crystal compound 18 of the liquid crystal layer of the liquid crystal layer sets on both sides in the thickness direction, and the Δnd and the twisted angle of the liquid crystal compound 18 of the liquid crystal layer of the liquid crystal layer sets in the center in the thickness direction, optimum Δnd's and twisted angles with which the liquid crystal polarization interference element acts as a λ/2 retardation plate and the side lobe can be reduced may be set by simulation.

Preferably, a change in the twisted angle of the liquid crystal compound 18 from both sides toward the center in the stacking direction (thickness direction), and a distribution of the Δnd of the liquid crystal layer of the liquid crystal layer set are controlled as gradually and finely as possible.

In the filter 10 shown in FIG. 1, in each liquid crystal layer, the liquid crystal compound 18 is a rod-like liquid crystal compound, and the liquid crystal layer is formed of only the rod-like liquid crystal compound. However, the present invention is not limited thereto.

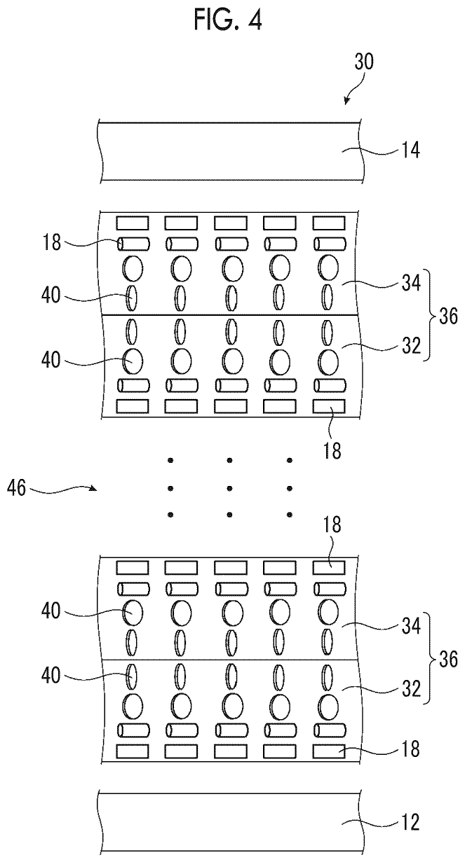

That is, in the filter according to the embodiment of the present invention, the liquid crystal layer may have a disk-like liquid crystal compound in addition to the liquid crystal compound 18, as in a first liquid crystal layer 32 and a second liquid crystal layer 34 of a filter 30 shown in FIG. 4.

In the following description, the liquid crystal compound 18 is also referred to as a rod-like liquid crystal compound 18 to clearly distinguish it from a disk-like liquid crystal compound 40. In addition, in the filter 30 shown in FIG. 4, the same members are denoted by the same reference numerals, and in the following description, different members will be mainly described.

In the filter 30 shown in FIG. 4, the first liquid crystal layer 32 and the second liquid crystal layer 34 are formed by fixing the rod-like liquid crystal compound 18 and the disk-like liquid crystal compound 40 that are twisted and aligned in a thickness direction.

In addition, in the filter 30, the twisted direction of the liquid crystal compound in the first liquid crystal layer 32 is opposite to that in the second liquid crystal layer 34, and the twisted angle of the liquid crystal compound in the first liquid crystal layer 32 is the same as that in the second liquid crystal layer 34. That is, a total twisted angle of the rod-like liquid crystal compound 18 and the disk-like liquid crystal compound 40 in the first liquid crystal layer 32 and the second liquid crystal layer 34 is in a relationship of “φ” and “−φ” as in the above-described example.

Furthermore, in the filter 30, the alignment directions of the liquid crystal compound are parallel to each other at an interface between the first liquid crystal layer 32 and the second liquid crystal layer 34.

In the filter 30 shown in FIG. 4, in the thickness direction from the lower side to the upper side in the drawing, the first liquid crystal layer 32 has the rod-like liquid crystal compound 18 twisted and aligned in the thickness direction, and then has the disk-like liquid crystal compound 40 twisted and aligned in the thickness direction.

On the other hand, the second liquid crystal layer 34 on the first liquid crystal layer 32 has, in the thickness direction from the lower side to the upper side in the drawing, the disk-like liquid crystal compound 40 twisted and aligned in the thickness direction, and has the rod-like liquid crystal compound 18 twisted and aligned in the thickness direction on the disk-like liquid crystal compound 40. The twisted alignment directions of the liquid crystal compound in the first liquid crystal layer 32 is opposite to that in the second liquid crystal layer 34.

The filter 30 also has a liquid crystal polarization interference element 46 in which the first liquid crystal layer 32 and the second liquid crystal layer 34 are alternately stacked, and the liquid crystal polarization interference element 46 has three or more liquid crystal layer sets each consisting of the first liquid crystal layer 32 and the second liquid crystal layer 34.

In the example shown in FIG. 4, in a liquid crystal layer set 36, the first liquid crystal layer 32 is provided to have an order of “rod-like liquid crystal compound/disk-like liquid crystal compound” and the second liquid crystal layer 34 is provided to have an order of “disk-like liquid crystal compound/rod-like liquid crystal compound” in the thickness direction from the bottom to the top in the drawing, but the present invention is not limited thereto. For example, in the filter according to the embodiment of the present invention, in the liquid crystal layer set, the first liquid crystal layer may be provided to have an order of “rod-like liquid crystal compound/disk-like liquid crystal compound” and the second liquid crystal layer may be provided to have an order of “rod-like liquid crystal compound/disk-like liquid crystal compound”.

In addition, the number, order, and thickness of the regions consisting of the rod-like liquid crystal compound 18 and the regions consisting of the disk-like liquid crystal compound 40 may be appropriately changed under the condition that the sum of the Δnd of each of the liquid crystal layers and the twisted angle of the liquid crystal compound does not change.

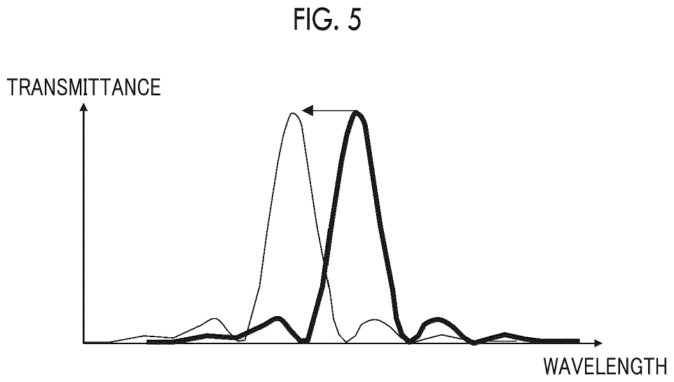

As conceptually shown in FIG. 5, in the band-pass filter, a wavelength shift in which a transmission wavelength range moves to a shorter wavelength side occurs during light incidence from an oblique direction.

Regarding this, the first liquid crystal layer 32 and the second liquid crystal layer 34 each have a region consisting of the rod-like liquid crystal compound 18 and a region consisting of the disk-like liquid crystal compound 40, so that the retardation (Rth) in the thickness direction between the first liquid crystal layer 32 and the second liquid crystal layer 34 can be reduced, and the wavelength shift (coloring) during light incidence from an oblique direction can be suppressed.

In a case where the first liquid crystal layer 32 and the second liquid crystal layer 34 each are formed of a region consisting of the rod-like liquid crystal compound 18 and a region consisting of the disk-like liquid crystal compound 40, a ratio of a thickness of the region consisting of the rod-like liquid crystal compound 18 to a thickness of the region consisting of the disk-like liquid crystal compound 40 is not limited.

Here, in a case where the first liquid crystal layer 32 and the second liquid crystal layer 34 each are formed of a region consisting of the rod-like liquid crystal compound 18 and a region consisting of the disk-like liquid crystal compound 40, the Δnd of the liquid crystal layer is preferably divided into two equal parts between the region consisting of the rod-like liquid crystal compound 18 and the region consisting of the disk-like liquid crystal compound 40 according to the Δn of the liquid crystal compound used.

In addition, the Δn's of the rod-like liquid crystal compound 18 and the disk-like liquid crystal compound 40 are preferably the same value from the viewpoint of reducing interfacial reflection, but a rod-like liquid crystal compound 18 and a disk-like liquid crystal compound 40 having different Δn's may be used.

The liquid crystal polarization interference element 46 consisting of liquid crystal layers having a region consisting of the rod-like liquid crystal compound 18 and a region consisting of the disk-like liquid crystal compound 40 can also be formed by a coating method using a composition that forms the region consisting of the rod-like liquid crystal compound 18 in the first liquid crystal layer 32, a composition that forms the region consisting of the disk-like liquid crystal compound 40 in the first liquid crystal layer 32, a composition that forms the region consisting of the disk-like liquid crystal compound 40 in the second liquid crystal layer 34, and a composition that forms the region consisting of the rod-like liquid crystal compound 18 in the second liquid crystal layer 34, as in the above description.

In a case where the region consisting of the disk-like liquid crystal compound 40 is formed on the region consisting of the rod-like liquid crystal compound 18 and in a case where the region consisting of the rod-like liquid crystal compound 18 is formed on the region consisting of the disk-like liquid crystal compound 40, the liquid crystal compound in the region formed on the upper side follows the alignment direction (longitudinal direction) of the liquid crystal compound in the region on the lower side, as in the above description.

Accordingly, as above, in the liquid crystal layer having the region consisting of the rod-like liquid crystal compound 18 and the region consisting of the disk-like liquid crystal compound 40, the liquid crystal compound is also continuously twisted and aligned in the thickness direction in one liquid crystal layer, and the alignment directions of the liquid crystal compound are parallel to each other at an interface between the first liquid crystal layer 32 and the second liquid crystal layer 34.

As described above, the present invention may be provided not only by directly stacking the liquid crystal layers (regions) using the coating method, but also by stacking and adhering the sheet-like liquid crystal layers with an OCA or the like.

In the present invention, in a case where the first liquid crystal layer 32 and the second liquid crystal layer 34 have a region consisting of the disk-like liquid crystal compound 40, the disk-like liquid crystal compound to be used is not limited, and various known compounds can be used.

As the disk-like liquid crystal compound, for example, compounds described in JP2007-108732A and JP2010-244038A can be preferably used.

In a case where the disk-like liquid crystal compound is used for the liquid crystal layer, the disk-like liquid crystal compound 40 rises in the thickness direction in the liquid crystal layer as shown in FIG. 4, and the optical axis derived from the liquid crystal compound is defined as an axis perpendicular to a disc plane, that is, a so-called fast axis.

In addition, both of the first liquid crystal layer 32 and the second liquid crystal layer 34 shown in FIG. 4 have one region consisting of the rod-like liquid crystal compound 18 and one region consisting of the disk-like liquid crystal compound 40, but the present invention is not limited thereto.

That is, in the present invention, in a case where the first liquid crystal layer and the second liquid crystal layer have a region consisting of a rod-like liquid crystal compound and a region consisting of a disk-like liquid crystal compound, one liquid crystal layer may have a plurality of regions consisting of the rod-like liquid crystal compound and/or a plurality of regions consisting of the disk-like liquid crystal compound.

In this case, the number of the plurality of layers is preferably increased by further subdividing the region consisting of the rod-like liquid crystal compound and the region consisting of the disk-like liquid crystal compound in one liquid crystal layer. Therefore, the difference between the retardation in a front direction (normal direction) and the retardation at a polar angle can be reduced within a wide azimuthal angle range.

The twisted angle and the twisted direction of the liquid crystal compound in the first liquid crystal layer 32 and the second liquid crystal layer 34 constituting the liquid crystal polarization interference element 46 can be detected by obliquely cutting the liquid crystal polarization interference element 46 and analyzing the alignment direction of the liquid crystals on the surface of the cross section. This method is described in detail in the above-described document written by Yohei Takahashi et al.

In the band-pass filter according to the embodiment of the present invention, the transmission axes of the polarizers in crossed nicols provided with the liquid crystal polarization interference element 46 interposed therebetween are preferably set at an appropriate angle in order to preferably obtain desired band-pass characteristics. As a preferable example, the angle of the transmission axes can be adjusted so that the size of a side lobe occurring at wavelengths on both sides (longer wavelength side and shorter wavelength side) of the main band-pass wavelength is reduced, and the sizes of the side lobes on the longer wavelength side and the shorter wave side are made uniform.

In addition, in the band-pass filter according to the embodiment of the present invention, a retardation layer may be provided between one or both of the polarizers in crossed nicols provided with the liquid crystal polarization interference element 46 interposed therebetween and the liquid crystal polarization interference element 46.

The retardation layer brings about an effect of maintaining the orthogonal relationship of the polarization directions by the linear polarizers disposed in crossed nicols not only in a front direction but also in an off-axis oblique direction of the polarizer. Therefore, good band-pass characteristics similar to those in a front direction can be obtained even in an oblique direction. By making the in-plane slow axis of the retardation layer parallel to an absorption axis of any of the set of the polarizers in crossed nicols, the polarization state can be compensated to maintain the orthogonal relationship of the polarization direction in the oblique direction without influence in the front direction.

Examples of the retardation layer include a positive C-plate formed by vertical alignment of rod-like liquid crystals, a positive A-plate formed by horizontal alignment of rod-like liquid crystals, a negative C-plate formed by disk-like liquid crystals, a negative A-plate formed by disk-like liquid crystals, and a combination of the retardation layers such as a combination of the positive C-plate formed by vertical alignment of rod-like liquid crystals and the positive A-plate formed by horizontal alignment of rod-like liquid crystals. In addition, a B-plate (with an Nz factor of 0.1 to 0.9) that is a biaxial refractive index body can also be used as the retardation layer.

In the filter according to the embodiment of the present invention, the first liquid crystal layer and the second liquid crystal layer may contain an infrared absorbing colorant.

In a case where the first liquid crystal layer and the second liquid crystal layer contain the infrared absorbing colorant, it is possible to make the liquid crystal wavelength dispersion in the liquid crystal layer strongly normal dispersion. As a result, it is possible to narrow the wavelength range of light on which the liquid crystal polarization interference element acts as a λ/2 wavelength plate. That is, by adding the infrared absorbing colorant to the first liquid crystal layer and the second liquid crystal layer and making the liquid crystal wavelength dispersion in the liquid crystal layer strongly normal dispersion, it is possible to obtain a band-pass filter having a narrower transmission wavelength range.

As the infrared absorbing colorant, various infrared absorbing colorants that can reduce the difference in refractive index between the x direction and the y direction by being aligned in the same direction as the liquid crystal compound can be used.

The infrared absorbing colorant is not particularly limited as long as it is a colorant that absorbs infrared rays. Among these, the infrared absorbing colorant is preferably a dichroic colorant. The infrared rays are, for example, light having a wavelength of 700 to 900 m. In addition, the dichroic colorant refers to a colorant having properties in which the absorbance of molecules in a major axis direction is different from that in a minor axis direction.

As the infrared absorbing colorant, diketopyrrolopyrrole-based colorants, diimmonium-based colorants, phthalocyanine-based colorants, naphthalocyanine-based colorants, azo-based colorants, polymethine-based colorants, anthraquinone-based colorants, pyrylium-based colorants, squarylium-based colorants, triphenylmethane-based colorants, cyanine-based colorants, and aminium-based colorants.

In addition, as the infrared absorbing colorant, metal complex colorants and boron complex-based colorants can also be used.

The infrared absorbing colorant is described in detail in WO2019/044859A.

The amount of the infrared absorbing colorant to be added in the first liquid crystal layer and the second liquid crystal layer is not particularly limited, and may be appropriately set depending on the width of the transmission wavelength range required for the band-pass filter or the like.

In the filter according to the embodiment of the present invention, the first liquid crystal layer and the second liquid crystal layer may contain a liquid crystal elastomer.

Regarding the first liquid crystal layer and the second liquid crystal layer including the liquid crystal elastomer, even in a case where the liquid crystal layer is formed using the liquid crystal elastomer, the liquid crystal layer formed of a usual liquid crystal compound that is not an elastomer may include the liquid crystal elastomer.

In this way, in a case where the first liquid crystal layer and the second liquid crystal layer include a liquid crystal elastomer, the first liquid crystal layer and the second liquid crystal layer can have elasticity, and the thickness of the liquid crystal layer can be changed by stretching or contracting the filter in the plane direction.

The Δnd of the liquid crystal layer can be changed by changing the thickness of the liquid crystal layer. As a result, in the band-pass filter, it is possible to change the wavelength range of light transmitted through the filter. That is, in a case where the first liquid crystal layer and the second liquid crystal layer include a liquid crystal elastomer, the wavelength range can be made variable by stretching and contracting the liquid crystal layer, that is, the filter, and thus it is possible to actively control the wavelength in the band-pass filter.

The liquid crystal elastomer is not limited, and various known liquid crystal elastomers can be used.

As the liquid crystal elastomer, for example, a liquid crystal elastomer prepared using a liquid crystal monomer, a chiral agent, a crosslinking agent, and a plasticizer, described in JP2020-131638A, can be used. Therefore, mechanical properties are imparted to the liquid crystal elastomer, and rubber elasticity is given, which makes deformation according to an external force that is necessary for active wavelength control possible.

In a case where the first liquid crystal layer and the second liquid crystal layer are formed of a usual liquid crystal compound that is not an elastomer, and a liquid crystal elastomer is added to impart elasticity, the amount of the liquid crystal elastomer to be added is not limited, and may be appropriately set according to the required elasticity, that is, the control range of the transmission wavelength range.

Such a filter according to the embodiment of the present invention can be used at any wavelength. That is, the filter according to the embodiment of the present invention can be used for any electromagnetic waves such as ultraviolet rays, visible light, infrared rays, terahertz waves, and millimeter waves.

The filter according to the embodiment of the present invention has been described in detail as above, but the present invention is not limited to the above-described examples and various improvements and changes may be made without departing from the spirit of the present invention.

### EXAMPLES

Hereinafter, the characteristics of the present invention will be described in greater detail with examples. Materials, chemicals, used amounts, material amounts, ratios, treatment details, treatment procedures, and the like shown in the following examples can be appropriately changed within a range not departing from the scope of the present invention. Therefore, the range of the present invention will not be restrictively interpreted by the following specific examples.

### Preparation of Composition

As a liquid crystal composition for forming a liquid crystal layer in which a liquid crystal compound is twisted and aligned in a thickness direction, the following compositions C-1, C-2, D-1, and D-2 were prepared.

In each composition, “C” indicates that the main component of the liquid crystal compound is a rod-like liquid crystal compound, and “D” indicates that the main component of the liquid crystal compound is a disk-like liquid crystal compound. In addition, in each composition, “1” indicates that the chiral agent induces the right-handed twist of the liquid crystal compound, and “2” indicates that the chiral agent induces the left-handed twist of the liquid crystal compound.

Accordingly, the composition C-1 is a liquid crystal composition that forms a liquid crystal layer including a rod-like liquid crystal compound as a main component, in which a twisted direction of the liquid crystal compound in the thickness direction is right-handed, the composition C-2 is a liquid crystal composition that forms a liquid crystal layer including a rod-like liquid crystal compound as a main component, in which a twisted direction of the liquid crystal compound in the thickness direction is left-handed, the composition D-1 is a liquid crystal composition that forms a liquid crystal layer including a disk-like liquid crystal compound as a main component, in which a twisted direction of the liquid crystal compound in the thickness direction is right-handed, and the composition D-2 is a liquid crystal composition that forms a liquid crystal layer including a disk-like liquid crystal compound as a main component, in which a twisted direction of the liquid crystal compound in the thickness direction is left-handed.

Composition C-1

| | |
|---|---|
| Rod-Like Liquid Crystal Compound L-1 | 100.00 parts by mass |
| Chiral Agent Ch-A | 0.058 parts by mass |
| Polymerization Initiator (IRGACURE (registered trade name) 907, manufactured by BASF SE) | 3.00 parts by mass |
| Photosensitizer (KAYACURE DETX-S, manufactured by Nippon Kayaku Co., Ltd.) | 1.00 part by mass |
| Leveling Agent T-1 | 0.08 parts by mass |
| Methyl Ethyl Ketone | 2000.00 parts by mass |

Composition C-2

| | |
|---|---|
| Rod-Like Liquid Crystal Compound L-1 | 100.00 parts by mass |
| Chiral Agent Ch-B | 0.099 parts by mass |
| Polymerization Initiator (IRGACURE (registered trade name) 907, manufactured by BASF SE) | 3.00 parts by mass |
| Photosensitizer (KAYACURE DETX-S, manufactured by Nippon Kayaku Co., Ltd.) | 1.00 part by mass |
| Leveling Agent T-1 | 0.08 parts by mass |
| Methyl Ethyl Ketone | 2000.00 parts by mass |

Composition D-1

| | |
|---|---|
| Disk-Like Liquid Crystal Compound L-2 | 80.00 parts by mass |
| Disk-Like Liquid Crystal Compound L-3 | 20.00 parts by mass |
| Polymerization Initiator (IRGACURE (registered trade name) 907, manufactured by BASF SE) | 5.00 parts by mass |
| MEGAFACE F444 (manufactured by DIC Corporation) | 0.50 parts by mass |
| Chiral Agent Ch-2 | 0.033 parts by mass |
| Methyl Ethyl Ketone | 300.00 parts by mass |

Composition D-2

| | |
|---|---|
| Disk-Like Liquid Crystal Compound L-2 | 80.00 parts by mass |
| Disk-Like Liquid Crystal Compound L-3 | 20.00 parts by mass |
| Polymerization Initiator (IRGACURE (registered trade name) 907, manufactured by BASF SE) | 5.00 parts by mass |
| MEGAFACE F444 (manufactured by DIC Corporation) | 0.50 parts by mass |
| Chiral Agent Ch-3 | 0.033 parts by mass |
| Methyl Ethyl Ketone | 300.00 parts by mass |

Rod-Like Liquid Crystal Compound L-1 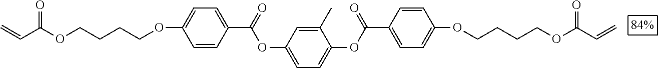 [SMILES: C=CC(=O)OCCCCOc1ccc(C(=O)Oc2ccc(OC(=O)c3ccc(OCCCCOC(=O)C=C)cc3)c(C)c2)cc1] 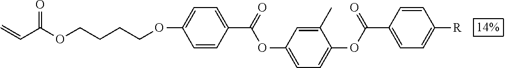 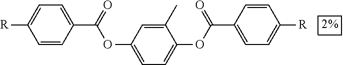 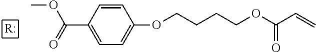
Disk-Like Liquid Crystal Compound L-2 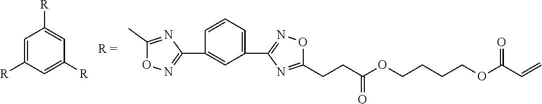
Disk-Like Liquid Crystal Compound L-3 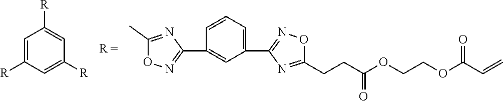
Leveling Agent T-1 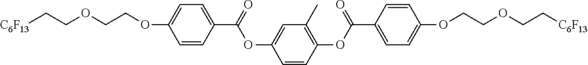
Chiral Agent Ch-A 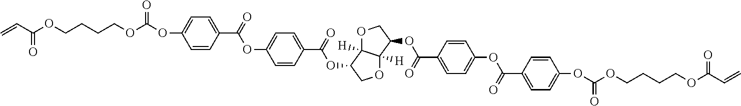 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]
Chiral Agent Ch-B 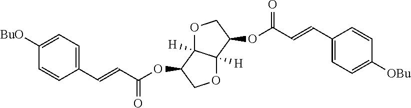
Chiral Agent Ch-2 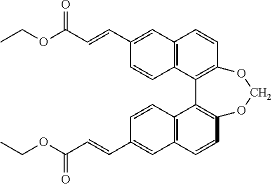
Chiral Agent Ch-3

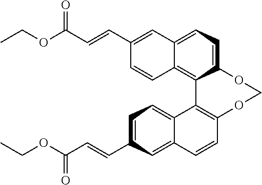

### Example 1

### Formation of Alignment Film

A glass substrate was prepared as a support. The following coating liquid for forming an alignment film was applied to the support by spin coating. The support on which the coating film of the coating liquid for forming an alignment film was formed was dried for 60 seconds on a hot plate at 60° C. As a result, an alignment film P-1 was formed.

Coating Liquid for Forming Alignment Film

| | |
|---|---|
| The Following Material for Photo-Alignment | 1.00 part by mass |
| Water | 16.00 parts by mass |
| Butoxyethanol | 42.00 parts by mass |
| Propylene Glycol Monomethyl Ether | 42.00 parts by mass |

Material for Photo-Alignment

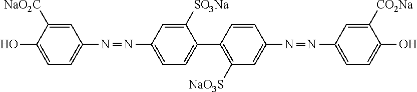

### Exposure of Alignment Film

Next, using an ultraviolet exposure device, the alignment film P-1 was irradiated with linearly polarized ultraviolet rays by a wire grid polarizer (ProFlux PPL02, manufactured by Moxtek, Inc.) installed so that the angle of a transmission axis was φ1 (=0°). In the ultraviolet light, the illuminance was 4.5 mW/cm², and the cumulative irradiation dose was 300 mJ/cm².

The angle of the transmission axis is an angle with respect to the longitudinal direction of the support, and is positive in the clockwise direction.

The composition C-1 was applied to the alignment film P-1 to form a first liquid crystal layer. That is, first, the composition C-1 was applied to the alignment film P-1. Then, the composition C-1 was heated, and then cured with ultraviolet rays to prepare a liquid crystal immobilized layer.

More specifically, for the liquid crystal immobilized layer, the composition C-1 was applied to the alignment film P-1 to obtain a coating film, the coating film was heated on a hot plate at 80° C., and then the coating film was irradiated with ultraviolet rays having a wavelength of 365 nm at an irradiation dose of 300 mJ/cm² using a high-pressure mercury lamp under a nitrogen atmosphere at 80° C. to immobilize the alignment of the liquid crystal compound, and thus the first liquid crystal layer was formed.

The thickness of the first liquid crystal layer was 1.72 μm.

Next, similarly, the composition C-2 was applied to the formed first liquid crystal layer, heated, and then cured with ultraviolet rays to form a second liquid crystal layer. The thickness of the second liquid crystal layer was 1.72 μm.

The first liquid crystal layer and the second liquid crystal layer were alternately formed to form a liquid crystal polarization interference element having eight liquid crystal layers (four liquid crystal layer sets) shown in Table 1 below (see FIG. 1).

TABLE 1

| | | | | Twisted Angle φ | |
|---|---|---|---|---|---|
| N | d [um] | Δn | Δnd [nm] | [°] | Composition |
| 1 | 1.72 | 0.16 | 275 | 17.7 | C1 |
| 2 | 1.72 | 0.16 | 275 | −17.7 | C2 |
| 3 | 1.72 | 0.16 | 275 | 17.7 | C1 |
| 4 | 1.72 | 0.16 | 275 | −17.7 | C2 |
| 5 | 1.72 | 0.16 | 275 | 17.7 | C1 |
| 6 | 1.72 | 0.16 | 275 | −17.7 | C2 |
| 7 | 1.72 | 0.16 | 275 | 17.7 | C1 |
| 8 | 1.72 | 0.16 | 275 | −17.7 | C2 |

Δn and a twisted angle φ of the liquid crystal compound were measured using AxoScan (manufactured by Axometrics, Inc.).

The twisted angle φ of the liquid crystal compound is an angle with respect to the direction of the transmission axis of the wire grid polarizer used for the exposure of the alignment film, and is positive in the clockwise direction.

The same also applies to the following examples with respect to the above points.

The alignment film was peeled off from the liquid crystal polarization interference element prepared as above, a linear polarizer was disposed on one side of the liquid crystal polarization interference element in the stacking direction so that the direction of the linearly polarized light irradiated on the alignment film was aligned with the transmission axis, and a linear polarizer was disposed on the other side in the stacking direction to be in crossed nicols. As a result, a band-pass filter was produced as shown in FIG. 1. As the linear polarizer, a polarizer having a configuration in which a transparent protective film was adhered to both front and rear surfaces of a polyvinyl alcohol film on which iodine was adsorbed and aligned was used.

Characteristics of the produced band-pass filter were measured using a spectroradiometer SR-3 manufactured by Topcon Technohouse Corporation.

As a result, the maximum transmittance was 99%, the central wavelength of transmitted light was 550 nm, and the half-width of transmitted light was 120 nm.

### Example 2

A liquid crystal polarization interference element having eight liquid crystal layers (four liquid crystal layer sets) shown in Table 2 below was formed in the same manner as in Example 1, except that
the amount of the chiral agent Ch-A in the composition C-1 was changed from 0.058 parts by mass to 0.039 parts by mass to form a composition C-3,
the amount of the chiral agent Ch-B in the composition C-2 was changed from 0.099 parts by mass to 0.067 parts by mass to form a composition C-4,
the amount of the chiral agent Ch-A in the composition C-1 was changed from 0.058 parts by mass to 0.076 parts by mass to form a composition C-5,
the amount of the chiral agent Ch-B in the composition C-2 was changed from 0.099 parts by mass to 0.129 parts by mass to form a composition C-6,
the composition C-3 was used for the formation of the first layer (first liquid crystal layer) and the seventh layer (first liquid crystal layer),
the composition C-4 was used for the formation of the second layer (second liquid crystal layer) and the eighth layer (second liquid crystal layer),
the composition C-5 was used for the formation of the third layer (first liquid crystal layer) and the fifth layer (first liquid crystal layer), and
the composition C-6 was used for the formation of the fourth layer (second liquid crystal layer) and the sixth layer (second liquid crystal layer). A film thickness d of each of the first, second, seventh, and eighth liquid crystal layers was 1.82 μm, and a film thickness d of the third to sixth liquid crystal layers was 1.67 μm.

TABLE 2

| | | | | Twisted Angle φ | |
|---|---|---|---|---|---|
| N | d [um] | Δn | Δnd [nm] | [°] | Composition |
| 1 | 1.82 | 0.16 | 291 | 12.6 | C3 |
| 2 | 1.82 | 0.16 | 291 | −12.6 | C4 |
| 3 | 1.67 | 0.16 | 267 | 22.4 | C5 |
| 4 | 1.67 | 0.16 | 267 | −22.4 | C6 |
| 5 | 1.67 | 0.16 | 267 | 22.4 | C5 |
| 6 | 1.67 | 0.16 | 267 | −22.4 | C6 |
| 7 | 1.82 | 0.16 | 291 | 12.6 | C3 |
| 8 | 1.82 | 0.16 | 291 | −12.6 | C4 |

Using this liquid crystal polarization interference element, a band-pass filter was produced in the same manner as in Example 1, and characteristics thereof were measured in the same manner as in Example 1.

As a result, the maximum transmittance was 99%, the central wavelength of transmitted light was 550 nm, and the half-width of transmitted light was 120 nm.

In addition, side lobes were measured with respect to the produced band-pass filter and the band-pass filter of Example 1 using a spectroradiometer SR-3 manufactured by Topcon Technohouse Corporation.

As a result, the side lobe of the band-pass filter of Example 1 was 10%, and the side lobe of the band-pass filter of Example 2 was 3% or less.

As above, in a case where, compared to the liquid crystal layer of the liquid crystal layer sets in the center in the thickness direction, the And of the liquid crystal layer of the liquid crystal layer sets on both sides in the thickness direction is increased and the twisted angle of the liquid crystal compound is reduced, the side lobe of the band-pass filter can be reduced.

The size of the sidelobe is a ratio of the transmittance of the side lobe to the transmittance of the central wavelength.

### Example 3

In the same manner as in Example 1, a region consisting of a rod-like liquid crystal compound and having a thickness of 0.86 μm was formed using the composition C-1, and a region consisting of a disk-like liquid crystal compound and having a thickness of 0.86 μm was formed thereon using the composition D-1 to form a first liquid crystal layer.

On the first liquid crystal layer, a region consisting of a disk-like liquid crystal compound and having a thickness of 0.86 μm was formed using the composition D-2, and a region consisting of a rod-like liquid crystal compound and having a thickness of 0.86 μm was formed thereon using the composition C-2 to form a second liquid crystal layer. Thus, a liquid crystal layer set was obtained.

The formation of the liquid crystal layer set was performed four times, and thus a liquid crystal polarization interference element having eight liquid crystal layers (four liquid crystal layer sets) as shown in Table 3 below was formed (see FIG. 4).

TABLE 3

| | | | | Twisted Angle φ | |
|---|---|---|---|---|---|
| N | d [um] | Δn | Δnd [nm] | [°] | Composition |
| 1 | 0.86 | 0.16 | 137.5 | 8.85 | C1 |
| | 0.86 | 0.16 | 137.5 | 8.85 | D1 |
| 2 | 0.86 | 0.16 | 137.5 | −8.85 | D2 |
| | 0.86 | 0.16 | 137.5 | −8.85 | C2 |
| 3 | 0.86 | 0.16 | 137.5 | 8.85 | C1 |
| | 0.86 | 0.16 | 137.5 | 8.85 | D1 |
| 4 | 0.86 | 0.16 | 137.5 | −8.85 | D2 |
| | 0.86 | 0.16 | 137.5 | −8.85 | C2 |
| 5 | 0.86 | 0.16 | 137.5 | 8.85 | C1 |
| | 0.86 | 0.16 | 137.5 | 8.85 | D1 |
| 6 | 0.86 | 0.16 | 137.5 | −8.85 | D2 |
| | 0.86 | 0.16 | 137.5 | −8.85 | C2 |
| 7 | 0.86 | 0.16 | 137.5 | 8.85 | C1 |
| | 0.86 | 0.16 | 137.5 | 8.85 | D1 |
| 8 | 0.86 | 0.16 | 137.5 | −8.85 | D2 |
| | 0.86 | 0.16 | 137.5 | −8.85 | C2 |

Using this liquid crystal polarization interference element, a band-pass filter was produced in the same manner as in Example 1 as shown in FIG. 4, and characteristics thereof were measured in the same manner as in Example 1.

As a result, the maximum transmittance was 99%, the central wavelength of transmitted light was 550 nm, and the half-width of transmitted light was 120 nm.

In addition, with respect to the produced band-pass filter and the band-pass filter of Example 1, a wavelength shift (absolute value) in a case where light was incident at a polar angle of 60° compared to a case where light was incident from a direction at a polar angle of 90° was measured using a spectroradiometer SR-3 manufactured by Topcon Technohouse Corporation. The light was incident at a polar angle of 60° from two directions, azimuth angles of 0° and 90°, and an average value was regarded as a measured value.

As a result, the wavelength shift of the central wavelength of transmission was 90 nm in the band-pass filter of Example 1, whereas the wavelength shift of the central wavelength of transmission was less than 5 nm in the band-pass filter of Example 3.

As above, in a case where the first liquid crystal layer and the second liquid crystal layer each have a region consisting of a rod-like liquid crystal compound and a region consisting of a disk-like liquid crystal compound, a wavelength shift in a case where light is obliquely incident can be reduced.

### Example 10

The amount of the chiral agent Ch-A in the composition C-1 was changed from 0.058 parts by mass to 0.038 parts by mass to obtain a composition C-11,
the amount of the chiral agent Ch-B in the composition C-2 was changed from 0.099 parts by mass to 0.066 parts by mass to obtain a composition C-12,
the amount of the chiral agent Ch-2 in the composition D-1 was changed from 0.033 parts by mass to 0.022 parts by mass to obtain a composition D-11,
the amount of the chiral agent Ch-3 in the composition D-2 was changed from 0.033 parts by mass to 0.022 parts by mass to obtain a composition D-12, and
a liquid crystal polarization interference element having liquid crystal layer sets shown in the following table in the same manner as in Example 3.

In the present example, the number of layers is changed from 8 to 12 and the twisted angle is changed compared to those of Example 3. In addition, the film thickness d of each liquid crystal layer is 0.86 μm.

TABLE 4

| | | | | Twisted Angle φ | |
|---|---|---|---|---|---|
| N | d [um] | Δn | Δnd [nm] | [°] | Composition |
| 1 | 0.86 | 0.16 | 137.5 | 5.9 | C11 |
| | 0.86 | 0.16 | 137.5 | 5.9 | D11 |
| 2 | 0.86 | 0.16 | 137.5 | −5.9 | D12 |
| | 0.86 | 0.16 | 137.5 | −5.9 | C12 |
| 3 | 0.86 | 0.16 | 137.5 | 5.9 | C11 |
| | 0.86 | 0.16 | 137.5 | 5.9 | D11 |
| 4 | 0.86 | 0.16 | 137.5 | −5.9 | D12 |
| | 0.86 | 0.16 | 137.5 | −5.9 | C12 |
| 5 | 0.86 | 0.16 | 137.5 | 5.9 | C11 |
| | 0.86 | 0.16 | 137.5 | 5.9 | D11 |
| 6 | 0.86 | 0.16 | 137.5 | −5.9 | D12 |
| | 0.86 | 0.16 | 137.5 | −5.9 | C12 |
| 7 | 0.86 | 0.16 | 137.5 | 5.9 | C11 |
| | 0.86 | 0.16 | 137.5 | 5.9 | D11 |
| 8 | 0.86 | 0.16 | 137.5 | −5.9 | D12 |
| | 0.86 | 0.16 | 137.5 | −5.9 | C12 |
| 9 | 0.86 | 0.16 | 137.5 | 5.9 | C11 |
| | 0.86 | 0.16 | 137.5 | 5.9 | D11 |
| 10 | 0.86 | 0.16 | 137.5 | −5.9 | D12 |
| | 0.86 | 0.16 | 137.5 | −5.9 | C12 |
| 11 | 0.86 | 0.16 | 137.5 | 5.9 | C11 |
| | 0.86 | 0.16 | 137.5 | 5.9 | D11 |
| 12 | 0.86 | 0.16 | 137.5 | −5.9 | D12 |
| | 0.86 | 0.16 | 137.5 | −5.9 | C12 |

Using this liquid crystal polarization interference element, a band-pass filter was produced in the same manner as in Example 1 as shown in FIG. 4, and characteristics thereof were measured in the same manner as in Example 1. As a result, the maximum transmittance was 99%, the central wavelength of transmitted light was 550 nm, and the half-width of transmitted light was 80 nm.

In addition, the wavelength shift was measured in the same manner as in Example 3. As a result, the wavelength shift was less than 5 nm.

### Example 11

A liquid crystal polarization interference element having liquid crystal layer sets shown in the following table was formed using a rod-like liquid crystal compound and a disk-like liquid crystal compound in the same manner as in Example 3.

The film thickness d of each liquid crystal layer is 1.72 μm.

TABLE 5

| | | | | Twisted Angle φ | |
|---|---|---|---|---|---|
| N | d [um] | Δn | Δnd [nm] | [°] | Composition |
| 1 | 1.72 | 0.16 | 275 | 17.7 | C1 |
| 2 | 1.72 | 0.16 | 275 | −17.7 | D2 |
| 3 | 1.72 | 0.16 | 275 | 17.7 | C1 |
| 4 | 1.72 | 0.16 | 275 | −17.7 | D2 |
| 5 | 1.72 | 0.16 | 275 | 17.7 | C1 |
| 6 | 1.72 | 0.16 | 275 | −17.7 | D2 |
| 7 | 1.72 | 0.16 | 275 | 17.7 | C1 |
| 8 | 1.72 | 0.16 | 275 | −17.7 | D2 |

Using this liquid crystal polarization interference element, a band-pass filter was produced in the same manner as in Example 1, and characteristics thereof were measured in the same manner as in Example 1. As a result, the maximum transmittance was 99%, the central wavelength of transmitted light was 550 nm, and the half-width of transmitted light was 120 nm.

In addition, the wavelength shift was measured in the same manner as in Example 3. As a result, the wavelength shift was less than 10 nm.

### Example 12

A liquid crystal polarization interference element having liquid crystal layer sets shown in the following table was formed using a rod-like liquid crystal compound and a disk-like liquid crystal compound in the same manner as in Example 3.

In the present example, the order of the rod-like liquid crystal compound layers and the disk-like liquid crystal compound layers is different from that of Example 3. In addition, the film thickness d of each liquid crystal layer is 0.86 μm.

TABLE 6

| | | | | Twisted Angle φ | |
|---|---|---|---|---|---|
| N | d [um] | Δn | Δnd [nm] | [°] | Composition |
| 1 | 0.86 | 0.16 | 137.5 | 8.85 | C1 |
| | 0.86 | 0.16 | 137.5 | 8.85 | D1 |
| 2 | 0.86 | 0.16 | 137.5 | −8.85 | C2 |
| | 0.86 | 0.16 | 137.5 | −8.85 | D2 |
| 3 | 0.86 | 0.16 | 137.5 | 8.85 | C1 |
| | 0.86 | 0.16 | 137.5 | 8.85 | D1 |
| 4 | 0.86 | 0.16 | 137.5 | −8.85 | C2 |
| | 0.86 | 0.16 | 137.5 | −8.85 | D2 |
| 5 | 0.86 | 0.16 | 137.5 | 8.85 | C1 |
| | 0.86 | 0.16 | 137.5 | 8.85 | D1 |
| 6 | 0.86 | 0.16 | 137.5 | −8.85 | C2 |
| | 0.86 | 0.16 | 137.5 | −8.85 | D2 |
| 7 | 0.86 | 0.16 | 137.5 | 8.85 | C1 |
| | 0.86 | 0.16 | 137.5 | 8.85 | D1 |
| 8 | 0.86 | 0.16 | 137.5 | −8.85 | C2 |
| | 0.86 | 0.16 | 137.5 | −8.85 | D2 |

Using this liquid crystal polarization interference element, a band-pass filter was produced in the same manner as in Example 1 as shown in FIG. 4, and characteristics thereof were measured in the same manner as in Example 1. As a result, the maximum transmittance was 99%, the central wavelength of transmitted light was 550 nm, and the half-width of transmitted light was 120 nm.

In addition, the wavelength shift was measured in the same manner as in Example 3. As a result, the wavelength shift was less than 4 nm.

### Example 13

A liquid crystal polarization interference element having liquid crystal layer sets shown in the following table was formed using a rod-like liquid crystal compound and a disk-like liquid crystal compound in the same manner as in Example 3.

In the present example, the order of the rod-like liquid crystal compound layers and the disk-like liquid crystal compound layers and the number of the layers are different from those of Example 3. In addition, the film thickness d of each liquid crystal layers is 0.43 μm.

TABLE 7

| | | | | Twisted Angle φ | |
|---|---|---|---|---|---|
| N | d [um] | Δn | Δnd [nm] | [°] | Composition |
| 1 | 0.43 | 0.16 | 68.8 | 4.425 | C1 |
| | 0.43 | 0.16 | 68.8 | 4.425 | D1 |
| | 0.43 | 0.16 | 68.8 | 4.425 | C1 |
| | 0.43 | 0.16 | 68.8 | 4.425 | D1 |
| 2 | 0.43 | 0.16 | 68.8 | −4.425 | C2 |
| | 0.43 | 0.16 | 68.8 | −4.425 | D2 |
| | 0.43 | 0.16 | 68.8 | −4.425 | C2 |
| | 0.43 | 0.16 | 68.8 | −4.425 | D2 |
| 3 | 0.43 | 0.16 | 68.8 | 4.425 | C1 |
| | 0.43 | 0.16 | 68.8 | 4.425 | D1 |
| | 0.43 | 0.16 | 68.8 | 4.425 | C1 |
| | 0.43 | 0.16 | 68.8 | 4.425 | D1 |
| 4 | 0.43 | 0.16 | 68.8 | −4.425 | C2 |
| | 0.43 | 0.16 | 68.8 | −4.425 | D2 |
| | 0.43 | 0.16 | 68.8 | −4.425 | C2 |
| | 0.43 | 0.16 | 68.8 | −4.425 | D2 |
| 5 | 0.43 | 0.16 | 68.8 | 4.425 | C1 |
| | 0.43 | 0.16 | 68.8 | 4.425 | D1 |
| | 0.43 | 0.16 | 68.8 | 4.425 | C1 |
| | 0.43 | 0.16 | 68.8 | 4.425 | D1 |
| 6 | 0.43 | 0.16 | 68.8 | −4.425 | C2 |
| | 0.43 | 0.16 | 68.8 | −4.425 | D2 |
| | 0.43 | 0.16 | 68.8 | −4.425 | C2 |
| | 0.43 | 0.16 | 68.8 | −4.425 | D2 |
| 7 | 0.43 | 0.16 | 68.8 | 4.425 | C1 |
| | 0.43 | 0.16 | 68.8 | 4.425 | D1 |
| | 0.43 | 0.16 | 68.8 | 4.425 | C1 |
| | 0.43 | 0.16 | 68.8 | 4.425 | D1 |
| 8 | 0.43 | 0.16 | 68.8 | −4.425 | C2 |
| | 0.43 | 0.16 | 68.8 | −4.425 | D2 |
| | 0.43 | 0.16 | 68.8 | −4.425 | C2 |
| | 0.43 | 0.16 | 68.8 | −4.425 | D2 |

Using this liquid crystal polarization interference element, a band-pass filter was produced in the same manner as in Example 1, and characteristics thereof were measured in the same manner as in Example 1. As a result, the maximum transmittance was 99%, the central wavelength of transmitted light was 550 nm, and the half-width of transmitted light was 120 nm.

In addition, the wavelength shift was measured in the same manner as in Example 3. As a result, the wavelength shift was less than 3 nm.

### Example 21

A liquid crystal polarization interference element same as in Example 12 was formed, except that, in Example 12, instead of forming the liquid crystal layers of the rod-like liquid crystal compound and the disk-like liquid crystal compound by continuous coating and alignment, the liquid crystal layers were formed, and then adhered with the following optical bonding layer. In that case, the liquid crystal layers were bonded so that slow axes of the interfaces between the liquid crystal layers were aligned in parallel with each other in the bonding surface.

A pressure-sensitive adhesive layer of SK-DYNE 2057 manufactured by Soken Chemical & Engineering Co., Ltd. was used as the optical bonding layer.

Using this liquid crystal polarization interference element, a band-pass filter was produced in the same manner as in Example 1 as shown in FIG. 4, and characteristics thereof were measured in the same manner as in Example 1. As a result, the maximum transmittance was 95%, the central wavelength of transmitted light was 550 nm, and the half-width of transmitted light was 120 nm.

In addition, the wavelength shift was measured in the same manner as in Example 3. As a result, the wavelength shift was less than 4 nm.

### Example 31

In Example 12, a retardation layer was disposed between the first polarizer 12 as a linear polarizer and the liquid crystal polarization interference element 16 of the band-pass filter shown in FIG. 4. The retardation layer brings about an effect of maintaining the orthogonal relationship of the polarization directions by the linear polarizers disposed in crossed nicols not only in a front direction but also in an oblique direction.

Specifically, as the retardation layer, a positive C plate (having a retardation Rth of −90 nm in the thickness direction) formed by vertical alignment of a rod-like liquid crystal compound and a positive A plate (having a retardation Re of 140 nm in the in-plane direction) formed by horizontal alignment of a rod-like liquid crystal compound were disposed and adhered in this order adjacent to the first polarizer 12. In this case, the in-plane slow axis of the positive A plate was installed in parallel with the absorption axis of the first polarizer 12.

In this manner, a band-pass filter was produced.

Characteristics of the band-pass filter were measured in the same manner as in Example 1. As a result, the maximum transmittance was 99%, the central wavelength of transmitted light was 550 nm, and the half-width of transmitted light was 120 nm.

In addition, the wavelength shift was measured in the same manner as in Example 3. As a result, the wavelength shift was less than 3 nm.

### Example 4

In Example 1, a band-pass filter was produced in the same manner as in Example 1 by simulation, using a liquid crystal polarization interference element in which an infrared absorbing colorant was added to a first liquid crystal layer and a second liquid crystal layer.

The infrared absorbing colorant had dichroic absorption in the near infrared region, and was aligned in the same direction as the liquid crystal compound as a guest colorant in the liquid crystal compound serving as a host.

As a result, in the produced liquid crystal layer, Δn (450)/Δn (650) was 1.4, the maximum transmittance of the band-pass filter was 99%, the central wavelength of transmitted light was 550 nm, and the half-width of transmitted light was 60 nm.

As described above, in the band-pass filter of Example 1, the maximum transmittance is 99%, the central wavelength of transmitted light is 550 nm, and the half-width of transmitted light is 120 nm. As above, by adding the infrared absorbing colorant to the first liquid crystal layer and the second liquid crystal layer, the half-width of transmitted light is narrowed, and thus it is possible to obtain a band-pass filter having a narrower wavelength range of transmitted light.

### Example 5

In Example 1, a band-pass filter was produced in the same manner as in Example 1 by simulation, using a liquid crystal elastomer as a rod-like liquid crystal compound forming a first liquid crystal layer and a second liquid crystal layer.

The liquid crystal elastomer used was a liquid crystal elastomer prepared using a liquid crystal monomer, a chiral agent, a crosslinking agent, and a plasticizer, described in JP2020-131638A.

The maximum transmittance of the band-pass filter was 99%, the central wavelength of transmitted light was 550 nm, and the half-width of transmitted light was 60 nm.

In addition, the liquid crystal polarization interference element of the produced band-pass filter could be stretched by 20%, and the central wavelength of transmitted light could be controlled to 50 nm by stretching.

From the above results, the present invention shows definite effects.

The filter according to the embodiment of the present invention can be suitably used as a band-pass filter or the like in various optical devices.

### Explanation of References

10, 30: filter
12: first polarizer
14: second polarizer
16, 46: liquid crystal polarization interference element
18: liquid crystal compound (rod-like liquid crystal compound)
20, 32: first liquid crystal layer
24, 34: second liquid crystal layer
26, 36: liquid crystal layer set

What is claimed is:

1. A filter comprising:
three or more liquid crystal layer sets in a thickness direction, each consisting of
a first liquid crystal layer formed by fixing a liquid crystal compound twisted and aligned in the thickness direction, and
a second liquid crystal layer formed by fixing the liquid crystal compound twisted and aligned in the thickness direction, in which a twisted direction of the liquid crystal compound is opposite to a twisted direction of the liquid crystal compound in the first liquid crystal layer,
wherein, in the liquid crystal layer set, an alignment direction of the liquid crystal compound on a surface of the first liquid crystal layer on a second liquid crystal layer side is parallel to an alignment direction of the liquid crystal compound on a surface of the second liquid crystal layer on a first liquid crystal layer side, and
a twisted angle of the liquid crystal compound in the first liquid crystal layer and a twisted angle of the liquid crystal compound in the second liquid crystal layer are equal.

2. The filter according to claim 1, further comprising:
polarizers between which the three or more liquid crystal layer sets are interposed in the thickness direction,
wherein the polarizers between which the three or more liquid crystal layer sets are interposed in the thickness direction are disposed so that transmission axes of the polarizers are orthogonal to each other.

3. The filter according to claim 1,
wherein the twisted angle of the liquid crystal compound in the first liquid crystal layer and the second liquid crystal layer and Δnd in the first liquid crystal layer and the second liquid crystal layer are different between the liquid crystal layer sets disposed on both sides in the thickness direction and the liquid crystal layer sets disposed in a center portion in the thickness direction.

4. The filter according to claim 1,
wherein the liquid crystal compound in the first liquid crystal layer includes a rod-like liquid crystal compound and a disk-like liquid crystal compound, and the liquid crystal compound in the second liquid crystal layer includes a rod-like liquid crystal compound and a disk-like liquid crystal compound.

5. The filter according to claim 1,
wherein the first liquid crystal layer and the second liquid crystal layer include an infrared absorbing colorant.

6. The filter according to claim 1,
wherein the first liquid crystal layer and the second liquid crystal layer include a liquid crystal elastomer.

7. The filter according to claim 1,
wherein, in a case where a total number of the first liquid crystal layers and the second liquid crystal layers stacked is denoted by N and the twisted angle of the liquid crystal compound in the first liquid crystal layer and the second liquid crystal layer is denoted by ±φ [°], the following expression is satisfied,
$$0.9 \times ( 129.05 \times {N}^{- 0.961} ) \leq \vert φ \vert \leq 1.1 \times ( 129.05 \times {N}^{- 0.961} ) .$$

8. The filter according to claim 2, further comprising:
a retardation layer provided between one or both of the polarizers and the three or more liquid crystal layer sets,
wherein an in-plane slow axis of the retardation layer is parallel to an absorption axis of any of the polarizers.

9. The filter according to claim 2,
wherein the twisted angle of the liquid crystal compound in the first liquid crystal layer and the second liquid crystal layer and Δnd in the first liquid crystal layer and the second liquid crystal layer are different between the liquid crystal layer sets disposed on both sides in the thickness direction and the liquid crystal layer sets disposed in a center portion in the thickness direction.

10. The filter according to claim 2,
wherein the liquid crystal compound in the first liquid crystal layer includes a rod-like liquid crystal compound and a disk-like liquid crystal compound, and the liquid crystal compound in the second liquid crystal layer includes a rod-like liquid crystal compound and a disk-like liquid crystal compound.

11. The filter according to claim 2,
wherein the first liquid crystal layer and the second liquid crystal layer include an infrared absorbing colorant.

12. The filter according to claim 2,
wherein the first liquid crystal layer and the second liquid crystal layer include a liquid crystal elastomer.

13. The filter according to claim 2,
wherein, in a case where a total number of the first liquid crystal layers and the second liquid crystal layers stacked is denoted by N and the twisted angle of the liquid crystal compound in the first liquid crystal layer and the second liquid crystal layer is denoted by ±φ [°], the following expression is satisfied,
$$0.9 \times ( 129.05 \times {N}^{- 0.961} ) \leq \vert φ \vert \leq 1.1 \times ( 129.05 \times {N}^{- 0.961} ) .$$

14. The filter according to claim 3,
wherein the liquid crystal compound in the first liquid crystal layer includes a rod-like liquid crystal compound and a disk-like liquid crystal compound, and the liquid crystal compound in the second liquid crystal layer includes a rod-like liquid crystal compound and a disk-like liquid crystal compound.

15. The filter according to claim 3,
wherein the first liquid crystal layer and the second liquid crystal layer include an infrared absorbing colorant.

16. The filter according to claim 3,
wherein the first liquid crystal layer and the second liquid crystal layer include a liquid crystal elastomer.

17. The filter according to claim 3,
wherein, in a case where a total number of the first liquid crystal layers and the second liquid crystal layers stacked is denoted by N and the twisted angle of the liquid crystal compound in the first liquid crystal layer and the second liquid crystal layer is denoted by ±φ [°], the following expression is satisfied,
$$0.9 \times ( 129.05 \times {N}^{- 0.961} ) \leq \vert φ \vert \leq 1.1 \times ( 129.05 \times {N}^{- 0.961} ) .$$

18. The filter according to claim 3, further comprising:
a retardation layer provided between one or both of the polarizers and the three or more liquid crystal layer sets,
wherein an in-plane slow axis of the retardation layer is parallel to an absorption axis of any of the polarizers.

19. The filter according to claim 4,
wherein the first liquid crystal layer and the second liquid crystal layer include an infrared absorbing colorant.

20. The filter according to claim 4,
wherein the first liquid crystal layer and the second liquid crystal layer include a liquid crystal elastomer.
